(19) United States
(12) Patent Application Publication
(10) Pub. No.: US 2011/0174576 A1
(43) Pub. Date: Jul. 21, 2011

(54) METHOD FOR DRAINING FLUIDS FROM A FLUID CONTAINING UNIT OF AN ENGINE, MACHINE OR DRIVE TRANSMISION, A DRAINING ADAPTER TO BE USED IN THE METHOD AN ENGINE, MACHINE OR DRIVE TRANSMISION WHICH IS ADOPTED TO BE DRAINED BY THE METHOD

(75) Inventor: Staffan Mansson, Myggenas (SE)

(73) Assignee: AB Volvo Penta, Goteborg (SE)

(21) Appl. No.: 12/595,375

(22) PCT Filed: May 3, 2007
(86) PCT No.: PCT/SE2007/000426

§ 371 Date: Oct. 9, 2009

(51) Int. Cl. F16N 33/00; B63H 21/38; F15D 1/00; F16L 15/00

(52) U.S. Cl. 184/1.5; 440/88 R; 137/1; 285/390

(57) ABSTRACT

A method and a draining adapter are provided for draining fluids, especially lubricant oils, from an engine or machine like a combustion engine and especially from a boat drive or another engine which is not accessible from underneath in order to open an outlet and let the fluid flow out. Furthermore, an accordingly adapted engine or machine is disclosed for applying the method and the draining adapter

### BACKGROUND AND SUMMARY

The invention relates to a method and a draining adapter for draining fluids, like e.g. lubricant oil, from a fluid containing unit of an engine or machine, like a combustion engine, or of a drive transmission, especially comprising an angle gear, and especially of a boat drive. Furthermore, the invention relates to an accordingly adapted engine or machine or drive transmission, especially a marine drive transmission, for applying the method and draining adapter.

EP-A-1 078 850 discloses a drive device for an inboard and outboard propulsion machine applied to a drive unit and mounted through an opening of a boat-hull. It comprises an upper part of the drive unit disposed inside the hull and a lower part of the drive unit projecting through an opening of the hull into the water, wherein the upper part can be rotated with respect to the lower part. Furthermore, an oil communication passage is disposed at a joint portion between the upper and the lower part so that an upper oil circulation passage and an upper oil drain passage are respectively brough\into communication with a lower oil circulation passage and a lower oil drain passage, and, whichever the upper part is directed, the oil can be circulated through the same passages in the drive unit, and drained from the same oil drain outlet which is provided at the upper part in the hull so that the oil can be exchanged without lifting the boat out of the water.

However, a disadvantage of this drive device and oil communication system is, that it might be difficult or impossible to completely drain the oil from the lower part of the drive unit especially on the sea and under difficult environmental conditions.

It is desirable to provide a method and draining adapter with which fluids, especially lubricant oils, can be drained at least substantially completely and in an easy manner from a fluid containing unit as mentioned in the introductory part above, especially in such a case in which the unit is not or only under difficulties accessible at its bottom side in order to let the fluid flow out by opening a related outlet.

It is desirable to provide a method and draining adapter for draining fluids like lubricant oils especially from a marine drive transmission like a through-hull drive of a boat in a simple manner and at low cost.

It is desirable to provide an engine or machine or drive transmission, especially a marine drive transmission, which is advantageously adapted for draining fluids like lubricant oils in an easy manner by means of a method and draining adapter according to the invention.

According to an aspect of the present invention, a method is provided for draining fluids, especially lubricant oil, from a fluid containing unit of an engine or machine or drive transmission comprising a drive shaft which is provided with an axial passageway with a first opening for connecting with a low pressure source and a second opening which is positioned within the fluid containing unit, wherein the fluid is drained by sucking it out through the passageway by means of the low pressure source.

According to an aspect of the present invention, an engine or machine or drive transmission is provided which is adapted for conducting a method according to claim 1, comprising:
a drive shaft which extends into a fluid containing unit, wherein the driveshaft is provided with an axial passageway with a first opening at a first end of the passageway and a second opening which is positioned within the fluid containing unit,
a draining adapter comprising:
a through hole with a first axial end for providing a fluid connection with the first opening of the passageway of the driveshaft, leading into the fluid containing unit,
a second axial end for connecting with a low pressure source and
an attachment for sealingly connecting the draining adapter with the engine or machine or drive transmission, and
an attachment for attaching the draining adapter such that the passageway sealingly continues via its first opening to the through-hole of the draining adapter.

A major advantage of aspects of the inventive solutions is, that the fluid can be drained out of the engine or machine or drive transmission without dismantling the same or—in case of a boat—without lifting the boat out of the water.

Another advantage of aspects of the inventive solutions is, that the engine or machine or drive transmission needs only minor variations in its construction in order to apply the inventive method or the inventive draining adapter.

Another advantage of the method and adapter according to aspects of the invention is, that the fluid or oil can be drained out from an opening at a top side of the engine or machine or drive transmission and even out of those parts of the engine or machine or drive transmission which are positioned far below this opening.

### BRIEF DESCRIPTION OF THE DRAWINGS

Further details, features and advantages of the invention will become apparent from the following description of preferred embodiments of the invention in conjunction with the drawing, in which shows:

FIG. 1 diagrammatically a boat drive according to the invention in a cross section;

FIG. 2 an enlarged section A of FIG. 1 with a draining adapter according to the invention; and

FIG. 3 an enlarged section B of FIG. 1.

### DETAILED DESCRIPTION

The invention shall be explained exemplarily in the following with respect to a marine drive transmission as it is used e.g. in a through-hull boat drive, comprising a first upper drive unit 11 within the hull 10 of a boat and a second lower drive unit 12 or propulsion unit below the hull 10. However, the method and draining adapter according to the invention can be applied to other accordingly adapted boat drives or engines or machines or drive transmissions as well.

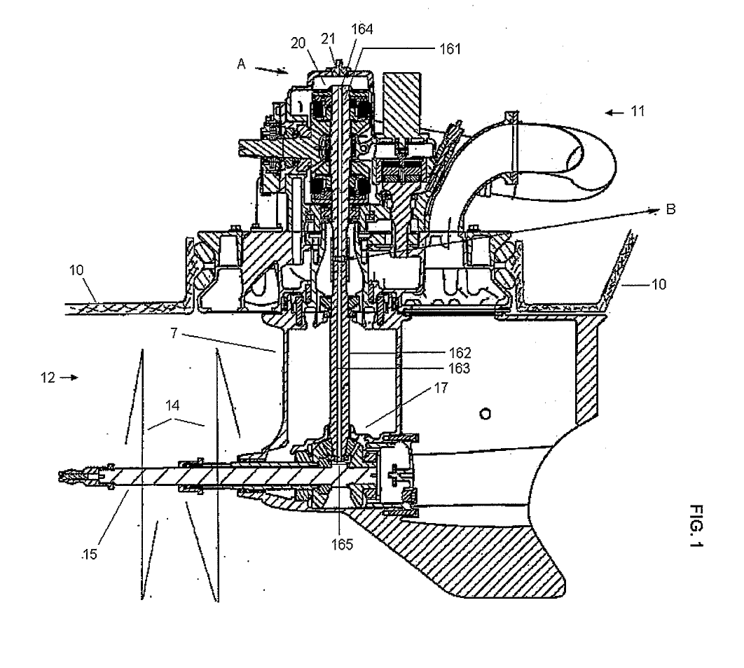

FIG. 1 schematically shows such a boat drive in a longitudinal section. The first upper drive unit 11 usually comprises a combustion engine, a gear, a first upper drive shaft 161 and other means and devices which are necessary for operating the engine and driving the drive shaft in a known manner. The second lower drive unit 12 is arranged below the hull 10 within the water and usually comprises a casing 7 into which a second lower drive shaft 162 extends in order to continue the first upper drive shaft 161 and to drive one or more propellers 14 via an angle gear 17 and a third horizontal drive shaft 15. For lubricating and cooling the angle gear 17 and other moving parts, the casing 7 furthermore comprises an oil containing area with a lubrication oil in a known manner.

The first and the second drive shafts 161, 162 are connected with each other by means of a connecting unit (A) which shall be explained below with reference to FIG. 3.

As indicated in FIG. 1, the first and the second drive shafts 161, 162 are provided with an axially extending passageway 163, which runs longitudinally through the whole length of both drive shafts 161, 162. This passageway 163 comprises a first upper opening 164 at a first axial end of the passageway 163 within an oil charging area 20 of the first upper unit 11 and a second lower opening 165 at a second axial end of the passageway 163 within the oil containing area of the casing 7.

The oil charging area 20 comprises an attachment, preferably in the form of a screw hole within the wall 22, for an oil filler cap or screw 21, so that the oil filler cap or screw 21 can be removed in order to fill-in oil (or another fluid) in a known manner.

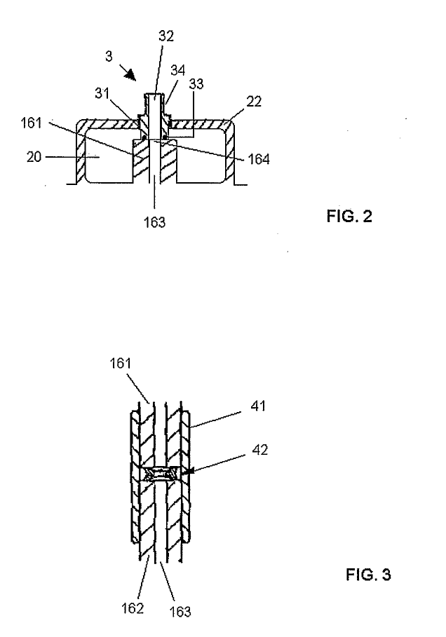

The oil charging area 20 is indicated in more details in cross section in FIG. 2. FIG. 2 shows the upper axial end of the first drive shaft 161 with the first axial end of the passageway 163 and its first upper opening 164.

In FIG. 2, the oil filler cap or a screw 21 has been removed. Instead, the oil charging area 20 is closed by a draining adapter 3 according to the invention which is provided for being attached, preferably by locking or screwing, in the same opening (i.e. the screw hole) in the wall 22 of the oil charging area 20 as the oil filler cap or screw 21.

In order to achieve this, the draining adapter 3 comprises an attachment 31 preferably in the same form as the oil filler cap or screw 21, i.e. an outer screw thread 31 (or another corresponding locking means) adapted to the attachment (preferably a screw hole) for the oil filler cap or screw 21 at the wall 22 of the oil charging area 20.

Furthermore, the draining adapter 3 comprises a first (lower) axial end which is dimensioned with respect to its axial length such that upon attaching the adapter 3 in the opening of the wall 22 of the oil charging area 20, it sealingly abuts with its lower axial end face at the upper axial end face of the first drive shaft 161, i.e. at the first axial end of the passageway 163.

In order to achieve an at least substantially air tight connection between these two faces, the draining adapter 3 is provided with a sealing O-ring 33 in its lower axial end face.

Furthermore, the draining adapter 3 comprises an axial through-hole 32 which extends in a longitudinal direction through the draining adapter 3 and comprises openings at both opposite ends. According to FIG. 2, this through hole 32 is dimensioned and oriented such that it continues the passageway 163 within the first drive shaft 161 when the draining adapter 3 is screwed into or attached in the said opening of the wall 22.

Finally, the second (upper) axial end 34 of the draining adapter 3 is formed preferably as a hose nipple which is provided for connecting a hose or pipe (not indicated) of a low pressure source (not indicated). Alternatively, the second upper axial end 34 and the hose or pipe can be connected with each other as well in another known way like e.g. by a bayonet locking.

For draining oil out of the oil containing area of the lower unit 12 of the boat drive, the oil filler cap or screw 21 is removed and the draining adapter 3 is instead screwed into or attached in the opening of the wall 22 of the oil charging area 20 until it sealingly abuts with its lower axial end face at the upper axial end face of the first drive shaft 161. Then, a hose or pipe is connected to the second axial end 34 of the draining adapter 3, and the oil is drained out (i.e. sucked up) from the oil containing area via the passageways 163, 161 and the draining adapter 3, by applying low pressure by means of a low (or negative) pressure source.

As mentioned above, the first and the second drive shaft 161, 162 are connected with each other by means of a connecting unit which is indicated in an enlarged cross-section in FIG. 3.

FIG. 3 shows the lower end section of the first drive draft 161 and the upper end section of the second drive shaft 162. These end sections are surrounded by a common sleeve of bushing 41 which is provided for transmitting the torque between both drive shafts and especially from the first drive shaft 161 to the second drive shaft 162.

Between both drive shafts 161, 162 a sealing ring 42 is positioned so that the low pressure which is applied at the upper opening of the first drive shaft 161 is maintained within the passageways 163 of both drive shafts 161, 162, and at least substantially no air is sucked through the gap between both drive shafts. Usually such a connection is provided as a brake-off section or breaking piece which allows a dislocation of the second lower driving unit 12 in case of a grounding without damaging the first upper driving unit 11 within the hull 10.

However, such a brake-off section is an option, and the drive shaft 161, 162 can as well be provided in one piece.

In order to suck out the oil as described above, it is advantageous to have an air inlet in the second lower driving unit 12, possibly in the lower section of the oil containing area which prevents the creation of a vacuum inside these areas and provides an under-pressure compensation. Alternatively, other openings within the second lower driving unit 12 which are provided for example for ventilation or other purposes, or inherent openings like non-gas tight connections in the second lower driving unit 12 can serve for this purpose as well.

1. Method for draining fluids from a fluid containing unit of an engine or machine or drive transmission, the engine, machine, or drive transmission comprising a drive shaft which is provided with an axial passageway with a first opening for connecting with a low pressure source and a second opening which is positioned within the fluid containing unit, comprising draining the fluid by sucking it out through the passageway with the low pressure source.

2. Method according to claim 1 for draining fluids from a fluid containing unit of a marine drive transmission which comprises an angle gear within the fluid containing unit, wherein the drive shaft is connected with the angle gear.

3. An engine or machine or drive transmission which is adapted for conducting a method according to claim 1, comprising:
a drive shaft which extends into a fluid containing unit, wherein the driveshaft is provided with an axial passageway with a first opening at a first end of the passageway and a second opening which is positioned within the fluid containing unit,
a draining adapter comprising:
a through hole with a first axial end for providing a fluid connection with the first opening of the passageway of the driveshaft, leading into the fluid containing unit,
a second axial end for connecting with a low pressure source and
an attachment for sealingly connecting the draining adapter with the engine or machine or drive transmission, and
an attachment for attaching the draining adapter such that the passageway sealingly continues via its first opening to the through-hole of the draining adapter.

4. An engine or machine or drive transmission according to claim 3, especially in the form of a marine drive transmission, comprising an angle gear to which the drive shaft is connected.

5. An engine or machine or drive transmission according to claim 3, wherein the fluid is an oil and the engine or machine or drive transmission is provided with an oil charging area into which the first opening of the passageway extends and which comprises an oil filler cap or screw within an outer opening of the oil charging area which opening is provided for attaching the draining adapter instead of the oil filler cap or screw.

6. An engine or machine or drive transmission according to claim 3, in the form of a through-hull drive of a boat or ship, comprising a first upper drive unit within the hull of the boat or ship and a second lower drive unit below the hull of the boat or ship, and wherein the drive shaft comprises a first upper drive shaft extending at least substantially within the first upper drive unit and a second lower drive shaft which continues the first upper drive shaft and extends at least substantially within the second lower drive unit.

7. An engine or machine or drive transmission according to claim 6, wherein the first and the second drive shaft are connected with each other by means of a sleeve or bushing for transmitting torque between both drive shafts and for providing a break-off section, and a sealing ring in order to provide an at least substantially gas tight connection between both drive shafts.

8. An engine or machine or drive transmission according to claim 6, especially of a steerable boat drive in which the second drive unit is rotatably connected with the first drive unit.

9. An engine or machine or drive transmission according to claim 3, wherein the first axial end comprises an axial end face with a sealing ring for sealingly abutting at the first opening of the passageway of the engine or machine or drive transmission, so that the through hole of the draining adapter sealingly continues the said passageway.

10. An engine or machine or drive transmission according to claim 3, comprising a second axial end which is formed to be connected with a hose or pipe of a low pressure source.

11. An engine or machine or drive transmission according to claim 3, wherein the attachment is provided in the form of an outer screw thread in an intermediate section between the first and a second axial end for screwing the draining adapter into a related opening of the engine or machine or drive transmission.
